(19) United States
(12) Patent Application Publication
(10) Pub. No.: US 2013/0235259 A1
(43) Pub. Date: Sep. 12, 2013

(54) METHODS AND SYSTEMS FOR ASSEMBLY OF CAMERA MODULES

(71) Applicant: Medha Dharmatilleke, Mason, OH (US)

(72) Inventor: Medha Dharmatilleke, Mason, OH (US)

(21) Appl. No.: 13/865,233

(22) Filed: Apr. 18, 2013

(30) Foreign Application Priority Data
Sep. 16, 2010 (SG) 201006753-6
Sep. 16, 2010 (SG) PCT/SG2010/000341
Oct. 4, 2010 (SG) PCT/SG2010/000378

(51) Int. Cl. H04N 5/225

(52) U.S. Cl. CPC H04N 5/2254
USPC 348/373

(57) ABSTRACT

A method and systems for assembly of camera modules is disclosed in which a pre-focused and pre-adjusted lens holder assembly is used in the assembly of camera modules. The use of pre-focused and pre-adjusted lens holder assembly increases the efficiency in the production of camera modules.

### BACKGROUND

1) Technical Field

Embodiment of invention related to systems and methods of mounting and adjusting of optical imaging lens modules for assembly of camera modules thereof, and methods of fabrication.

2) Description of Related Art

The common practice is to permanently mount the lens holder on the printed circuit board (PCB) where the imaging sensor is attached to. Subsequently, attach the optical lens module to the lens holder and screw in the lens module until a focused image is formed on the image sensor. Then permanently secure the lens onto the lens holder

Drawback of this method is the longer period of time and expertise needed to assemble the camera module.

With increasing demand for focus free assembly, of lenses during production of camera modules, improved methods are desired

### SUMMARY OF EMBODIMENTS OF THE INVENTION

Embodiments of the invention relate to assembly of camera modules without having to focus the optical lens module during assembly of the camera modules. The lens modules are pre focused and secured to the lens holder during the fabrication of the lens holder assembly. This eliminates the need to focus the lens after securing the holder on the PCB during assembly of camera modules. The lens holder assembly is then directly attached to the PCB or the image sensor. The alignment is easily achieved by using a few protrusions and/or alignment features which are built into the lens holder assembly. This forms the complete camera module, completing the assembly process.

### BRIEF DESCRIPTION OF THE DRAWINGS

FIG. 1 illustrate the lens holder 100 according to one embodiment of the invention. A cross sectional cut away view of the lens holder is shown with the protrusion 110 on the lens holder, which is used for alignment and spacing determination during assembly of the camera module.

FIG. 2 Illustrate the lens holder 200 according to one embodiment of the invention. When the optical lens module 210 is attached to the lens holder 100, the assembly is referred to as lens holder assembly 200 for ease of referring throughout in this document, in the descriptions, specifications and claims, etc.

FIG. 3 illustrates the lens holder assembly 200 mounted on the image sensor 320 according to one embodiment of the invention. Here, the image sensor 320 is mounted on a printed circuit board (PCB) 310. The assembly may also be called the camera module assembly 300.

FIG. 4 illustrates a cross sectional view of a camera system assembly or camera module assembly with an optical lens module 410 having the capability of focusing both far and near objects simultaneously onto a single focal plane. An image sensor 320 is placed at the focal plane, according to one embodiment of the invention. The optical lens module 410 may or may not have multiple components. Here the cross section is done in a plane parallel to the optical axis of the lens assembly.

FIG. 5 illustrates a cross sectional view of a camera system assembly or camera module assembly with an lens module 510 having the capability of focusing both far and near objects simultaneously onto a single focal plane. An image sensor 320 is placed at the focal plane. The optical lens module may or may not have multiple components. Here the cross section is done in a plane parallel to the optical axis of the lens assembly.

FIG. 6 illustrates an exemplary method and a scheme to assemble a camera module using the invention disclosed in the present invention.

### DETAILED DESCRIPTION OF ILLUSTRATIVE EMBODIMENTS

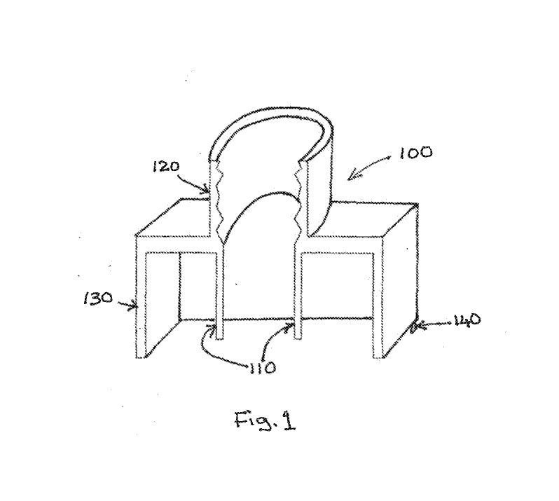

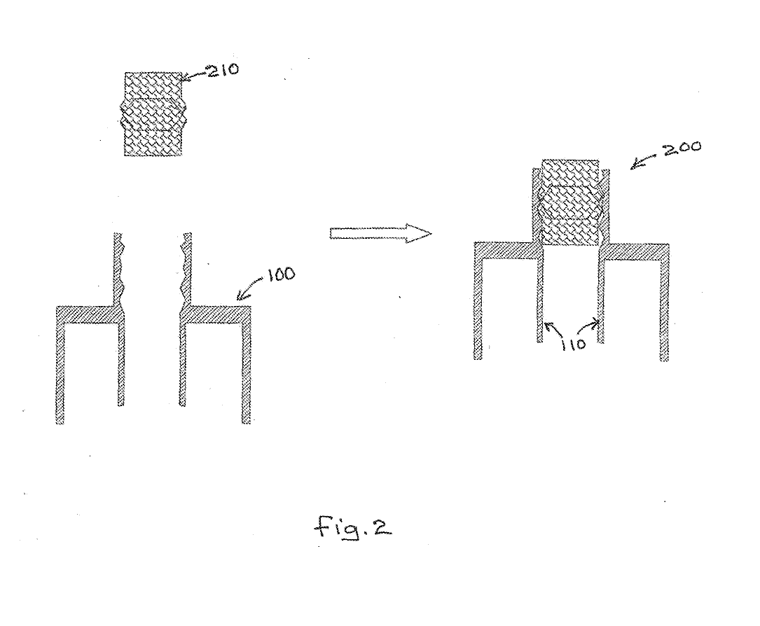

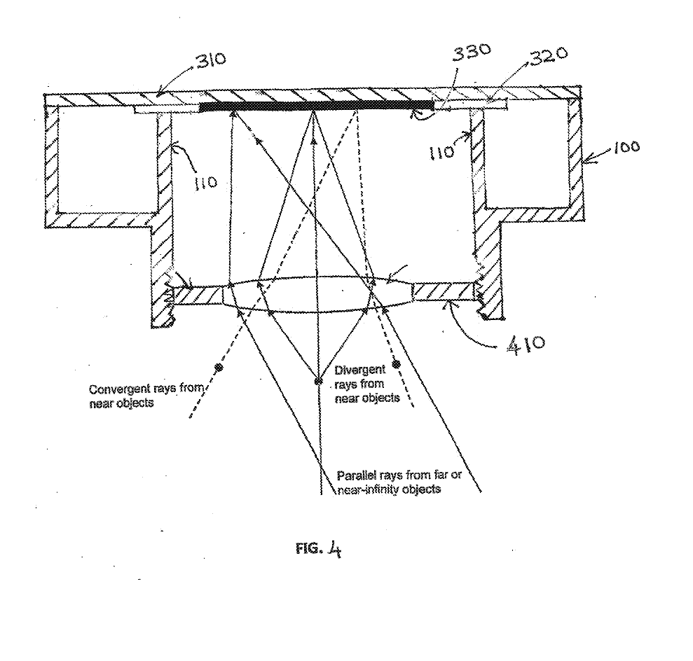

In the following description, numerous specific details are set for in order to provide a thorough understanding of various understanding of various illustrative embodiments of the present invention. It will be understood, however, to one skilled in the art, that embodiments of the present invention may be practiced without some or all of these specific details. In other instances, well known process operations have not been described in detail in order not to unnecessarily obscure pertinent aspects of embodiments being describe. In the drawings, like reference numerals refer to same or similar functionalities or features throughout the several views. It is to be appreciated that FIGS. 1, 2, 4, 5 and 6 are cross-sectional views taken from a plane parallel to an optical axis of the respective optical system. FIG. 3 is a partial inside view of the camera module.

Embodiments of the invention such as, but not limited to, those illustrated in FIGS. 1, 2, 3, 4, 5, 6, include an optical lens module, a lens holder to mount the optical lens, image sensor, printed circuit board, electronic components, and the other necessary components of a camera module.

A method and device to eliminate the need of adjusting the gap between the optical lens module and image sensor during the step of permanently assembling of camera modules is disclosed.

The usual practice is, in order to focus the image on the image sensor, the gap between the lens module and image sensor is adjusted after permanently attaching the holder assembly onto the image sensor or the printed circuit board (PCB) which contains the image sensor. Following the above method requires a lot of equipment, facilities, manpower and skill at the site where camera module assembly is done.

By using the method and scheme disclosed herein in this invention, the need to adjust the gap between the optical lens module and image sensor, after permanently attaching the lens holder assembly onto the image sensor or PCB, is eliminated. This leads to a cost effective assembly process, during assembly of camera modules at the site of camera module assembly.

According to one embodiment of the invention, the lens holder 100 is temporarily secured on a first image sensor so as to the protrusions 110 or the alignment features on the lens holder will come into contact with the top surface of the first image sensor. Subsequently, the optical lens module 210 is attached to the lens holder 100 and the gap between the first image sensor and optical lens module 210 is adjusted by suitable means until the image formed on the first image sensor, by the optical lens module 210 is focused to an acceptable level of focus. Then the optical lens module 210 may be permanently secured onto the lens holder 100 by means of an adhesive or other suitable means. It may not be necessary to permanently secure the optical lens module onto the lens holder assembly, if it is not required by the application. For ease of description, the unit consisting of the optical lens module attached to lens holder is referred to as “lens holder assembly” 200. Subsequently, the lens holder assembly 200 is detached from the first image sensor. Now this lens holder assembly can be directly attached to a second image sensor, to produce a camera module. It may not be necessary to re-adjust the focusing of the optical lens module since it has been pre adjusted with the first image sensor, which was attached temporarily. Here the protrusion on the lens holder assembly should be in contact with the second image sensor chip, in order to maintain a equal gap between the optical lens module and second image sensor and the optical lens module and first image sensor. Subsequently, the lens holder assembly is permanently attached to the image sensor 320 and for PCB 310 which contain the image sensor chip.

In another embodiment, the optical lens module 210 may be attached to the lens holder 100, prior to attaching it to the image sensor.

FIG. 1 illustrates a lens holder 100, where multiple protrusions 110 are present in the lens holder with which the lens holder is positioned on the image sensor 320, to provide a pre-determined gap between the optical lens module 210 and the image sensor 320. The protrusions 110 can be in the form of a continuous spacer or as individual columns or beams or other suitable structure which will enable to determine a equal gap between the lens module and image sensor. The lens holder 100 may or may not have secondary locator pins 140 which are used to align the lens holder 100 with the printed circuit board 310 where the image sensor 320 may be attached to.

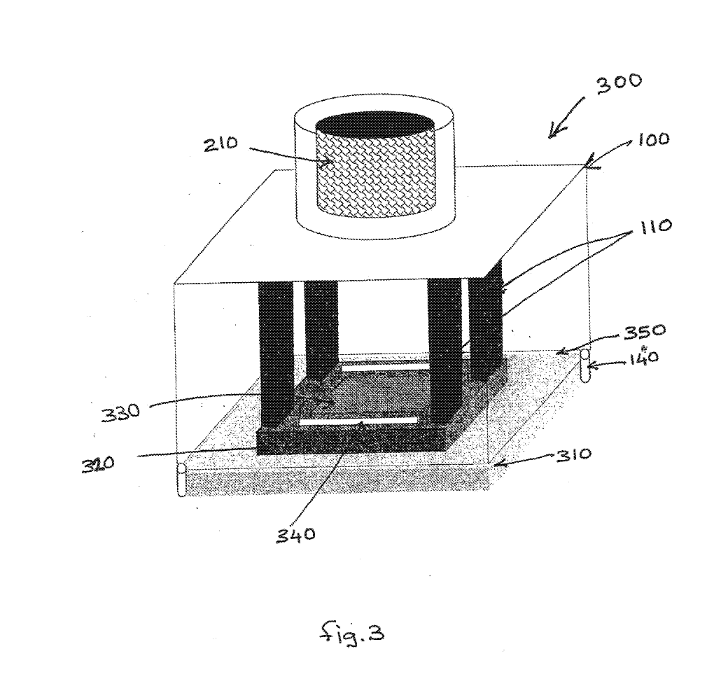

FIG. 2 illustrate how the optical lens module (210) is attached to the lens holder (100) in order to assemble the lens holder assembly (200). Here the optical lens module 210 is inserted to the opening on the lens holder 100, which is meant to be used for integrating both the optical lens module 210 and lens holder 100 together.

FIG. 3 illustrates the three dimensional view of the camera module 300. The lens holder assembly 200 having protrusions 110 is assembled in such a way that the protrusions 110 are in contact with the surface of the image sensor chip 320. In other words the protrusions 110 touches the surface of image sensor 320. It is preferred, although not necessary, to keep the imaging area 330 of the image sensor clear from getting in contact with components of the lens holder assembly 200. Imaging area 330 is the area where the active pixels are present on the image sensor 320. The image sensor 320 is attached to the printed circuit board 310, although the printed circuit board is not an essential component of the invention. By using the present invention disclosed herein, it is possible to assemble the camera module 300 without the use of the printed circuit board 310. In the instance, where the printed circuit board is not used, the image sensor 320 which is attached to the lens holder assembly 200 may be directly attached on to the main circuit board of the device by means of solder re-flow process used for soldering of other electronic components on to the main circuit board of the device. Here the device may be the mobile phone, camera, or any suitable device, which uses a camera module. A suitable sticky substance 340 is placed outside the imaging area 330 of the image sensor 320 to catch any unwanted loose particles which may have got into the environment of the image sensor 320. It should be noted the position, placement and geometry of the sticky substance 340 shown in FIG. 3 is only for illustrative purpose and can be different from what is shown in FIG. 3. The guide pins 140 used for positioning is not essential for the invention but is helpful to use the guide pins 140 to align the printed circuit hoard 310 with the lens holder assembly 200. The lens module 210 is shown in position. When the protrusions 110 come into contact with the surface of image sensor 320, there will exist a gap 350 between the printed circuit board and the lens holder assembly 200. In other words, there will be a gap 350 between the lens holder 100 and the printed circuit board 310, which will ensure the protrusions 110 are in contact with the surface of the image sensor 320. In other words, the gap 350 ensures that the protrusions 110 will touch the surface of the image sensor 320 in the camera module 300 which is assembled. A suitable adhesive may be used to permanently attach the lens holder assembly 200 to the printed circuit board. The adhesive may be used at the positions where the protrusions 110 are in contact with the image sensor 320 and/or at the areas where the lens holder 100 is near to the printed circuit board 310 or any other suitable locations.

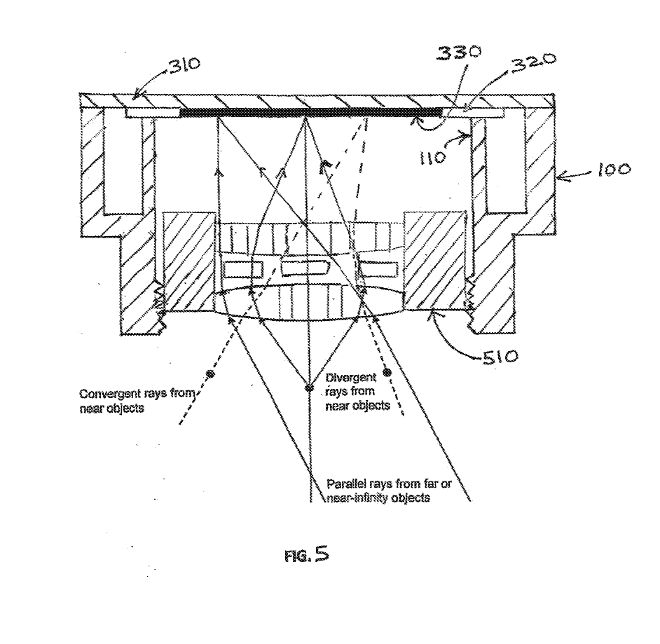

FIG. 4 illustrates one embodiment of the invention where an optical lens module 410 which is capable of focusing both far and near objects on to the imaging area 330 of image sensor 320 is integrated to become a camera module, using the invention disclose herein. It should be noted that this invention is not limited to using the optical lens 410, but can use any optical lens or lens module or lens module assembly.

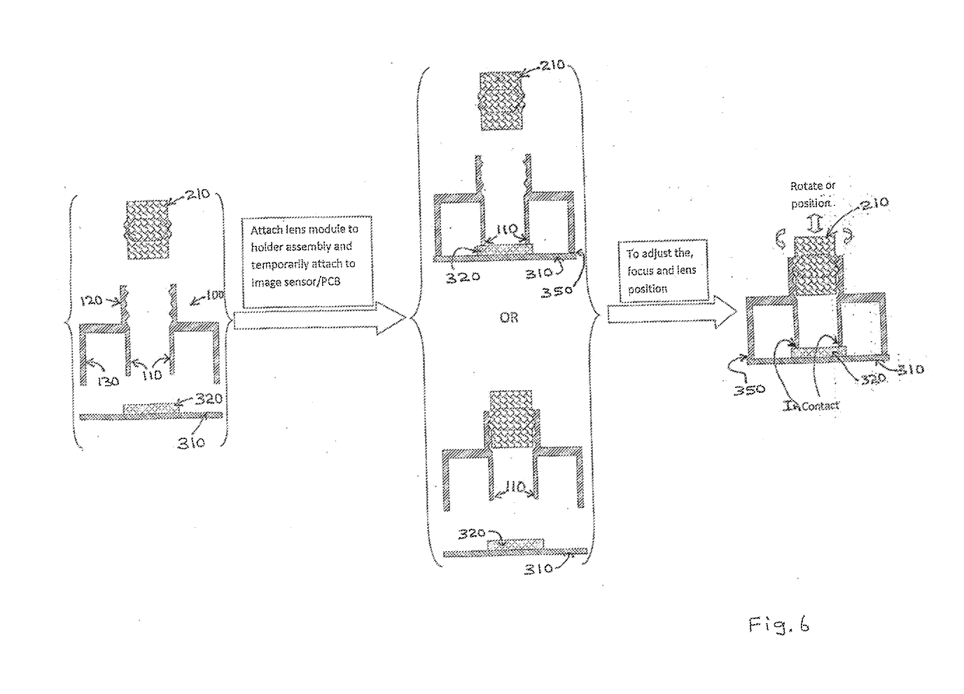

FIG. 5 illustrates one embodiment of the invention where an optical lens module 510 which is capable of focusing both far and near objects on to the imaging area 330 of image sensor 320 is integrated to become a camera module, using the invention disclose herein. It should be noted that this invention is not limited to using the optical lens 510, but can use any optical lens or lens module or lens module assembly.

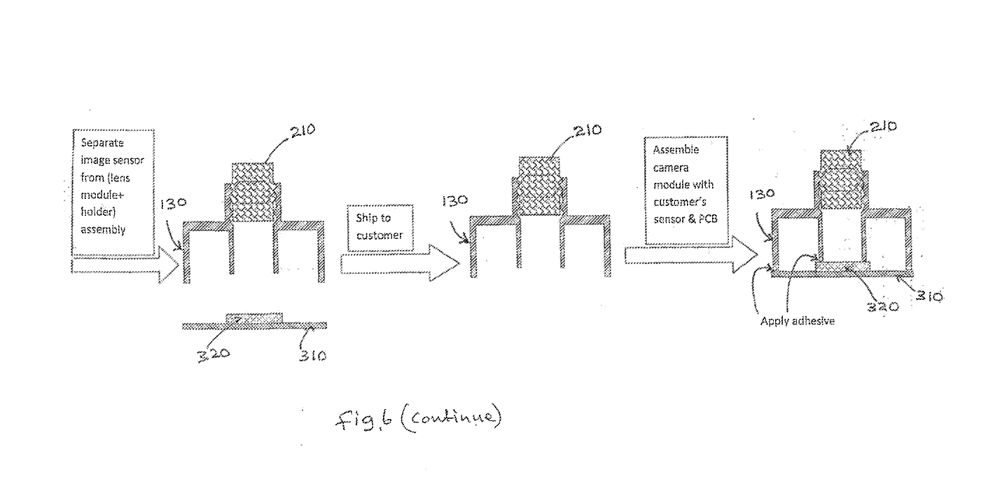

FIG. 6 illustrates a method and a scheme to assemble a camera module using the invention disclosed in the present invention. In the present disclosure, the method and scheme illustrated and described in FIG. 6 is used only for the purpose of ease of description and it should be noted that there are many variations of the procedure which will yield the same end results.

There may or may not be a protective layer, glass or other suitable layer or a cover over the image sensor.

The above describe method is exemplary, and it is to be understood that other methods of fabrication may be used with suitable modifications.

Other embodiments will be apparent to those skilled in the art from consideration of the specification and practice of the invention. Furthermore, certain terminology has been used for the purpose of descriptive clarity, and not to limit the embodiments and features described above should be considered exemplary, with the invention being defined by the appended claims.

Throughout this document, for ease of description, the unit which comprise both the lens module and the lens holder attached together (200) is collectively referred to as “lens holder assembly”.

Throughout this document, the first image sensor and the second image sensor may also be referred to as image sensor in the specifications, description and claims.

Throughout this document, the optical lens module may also be referred to as lens module, optical lens or lens.

What is claimed is:

1. A camera module comprising:
an image sensor
an optical lens module which is attached to a lens holder (“lens holder assembly”), where the optical lens is focused and adjusted after directly mounting the “lens holder assembly” on top of a first image sensor in such a way that the image obtained through the lens module is well focused on the first image sensor,
Thereby enabling the lens holder assembly be dismounted from the first image sensor and, be mounted on a second image sensor and to still be able to achieve good focused images on the second image sensor, without making any further changes to the set position of the lens module with respect to the lens holder which was set when used with the first image sensor,
The lens holder contain protrusions or appropriate features which may be used to position the lens holder with respect to the image sensor,
The first image sensor may or may not be mounted on a printed circuit board,
The second image sensor may or may not be mounted on a printed circuit hoard.

2. The lens holder assembly of claim 1, may be mounted either on top in contact with the image sensor or at a predetermined distance to the image sensor.

3. The lens holder assembly of claim 1, comprises a plurality of positioning features and may or may not comprise an infra red radiation cut (IR cut) filter. The positioning features will ensure the gap between the lens module and image sensor surface remain the same, even when the lens holder assembly (assembly comprising of the lens module and lens holder) is mounted on a second image sensor after detaching the lens holder assembly from a first image sensor. The first image sensor was used to adjust and focus the optical lens module position, with respect to both the lens holder and image sensor.

4. The lens holder assembly of claim 1, comprise a plurality of positioning features, which will rest or conic into contact with the surface of the image sensor or the protective surface layer of the image sensor or the cover of the image sensor or on top of any other suitable sensor or device or will rest or come into contact with the outside of image sensor chip.

5. The camera module of claim 1, wherein the lens holder assembly is temporarily attached to a first image sensor, in order to adjust the relative position of the optical lens module with respect to the lens holder and image sensor. The lens holder assembly is temporarily attached to a first image sensor by means of clamps, in order for adjusting the position/focus position of lens module with respect to the lens holder and image sensor.

6. The lens holder assembly of claim 1, comprises the lens module which is attached or screwed into the lens holder and subsequently the distance between the optical lens module and image sensor is adjusted until the image formed on the image sensor is focused as required. Subsequently, the optical lens module is secured onto the lens holder using glue or adhesive or ultra sonic welding or by any other suitable means.

7. The lens holder assembly of claim 1 will maintain a constant distance between the optical lens module and image sensor having an acceptable tolerance in the measurement of distance by means of the protrusions, even when the image sensors are interchanged. The protrusions can be on the holder or the image sensor or the printed circuit board or the lens module.

8. The image sensor of claim 1, may or may not contain a protective layer such as a glass or other suitable material layer or a cover on top of the sensor surface, which may or may not be in contact with the image sensor.

9. A method for pre focusing and adjusting the position of the optical lens module with respect to the image sensor and the lens holder in claim 1 comprises:
An optical lens module which is attached to a lens holder (i.e. lens holder assembly),
Temporary putting or getting the protrusions or the positioning/alignment features which are on the lens holder, in contact with a first image sensor and subsequently temporarily securing the lens holder assembly with the first image sensor,
Adjusting the position of the optical lens module with respect to lens holder and image sensor until the image is focused on a first image sensor,
Position of the optical lens module with respect to the lens holder may be fixed and secured if necessary. If necessary permanently attach the lens holder to the optical lens module,
Detaching the lens holder assembly (lens holder containing the optical lens module), from the first image sensor
Attaching the lens holder assembly (lens holder containing the optical lens module) onto a second image sensor,
Permanently secure the lens holder assembly onto the second image sensor
Alternatively, the lens holder assembly may be permanently attached to a printed circuit board onto which the second image sensor is attached.

10. A method for pre focusing/adjusting the position of the optical lens module with respect to the image sensor and the lens holder in claim 1 comprises:
Temporary putting or getting the protrusions or the positioning/alignment features which are on the lens holder, in contact with a first image sensor and subsequently temporarily securing the lens holder with the first image sensor,
Attaching the optical lens module onto the lens holder,
Adjusting the position of the optical lens module with respect to lens holder and image sensor until the image is focused on a first image sensor,
Position of the optical lens module with respect to the lens holder may be fixed and secured if necessary. If necessary permanently attach the lens holder to the optical lens module,
Detaching the lens holder assembly (lens holder containing the optical lens module), from the first image sensor
Attaching the lens holder assembly (lens holder containing the optical lens module) onto a second image sensor,
Permanently secure the lens holder assembly onto the second image sensor
Alternatively, the lens holder assembly may be permanently attached to a printed circuit hoard onto which the second image sensor is attached.

11. The focussing of the optical lens module of claim 1, may be achieved by moving the optical lens module with respect to the image sensor or with respect to the holder and subsequently, may or may not be permanently attached to the lens holder after focusing and adjusting the position of optical lens module, with respect to lens holder.

12. In claim 1, after detaching the first image sensor from the lens holder assembly (lens holder containing the optical lens module), the lens holder assembly may be attached to a second image sensor permanently while still achieving good focusing of image on the second image sensor.

13. The lens holder of claim 1, has protrusions or alignment features come into contact with the first and second image sensor. These protrusions may or may not remain in contact with the first and second image sensor, while and/or after integration of lens holder assembly with the first or second image sensor.

14. The protrusion or alignment features of claim 1, maintains a constant spacing between the optical lens module and image sensor when the lens holder assembly (lens holder containing the optical lens module) is mounted on different image sensors, during the assembly of camera modules.

15. The protrusion or alignment features of claim 1, can be a few individual pointers or a continuous structure which will enable to maintain a fixed distance between the optical lens module and image sensor.

16. In claim 1, the lens holder assembly may be permanently attached to the image sensor and/or the printed circuit board where the image sensor is attached, by using a suitable adhesive or by thermal bonding.

17. In claim 1, there may or may not be a gap between the holder and PCB.

18. In claim 1, a substance which is sticky is placed anywhere outside the imaging area of the image sensor but within the environment of image sensor to catch any loose particles which may be present in the environment of the image sensor.

19. In the camera module of claim 1, the optical lens module may or may not have protrusions or alignment features as an integral part of the lens module.
